(19) United States
(12) Patent Application Publication
(10) Pub. No.: US 2025/0237393 A1
(43) Pub. Date: Jul. 24, 2025

(54) WINDOW-TYPE LIQUID DESICCANT DEHUMIDIFICATION-VENTILATION SYSTEM

(71) Applicant: University of Seoul Industry Cooperation Foundation, Seoul (KR)

(72) Inventors: Dong Hwa KANG, Seoul (KR); Woo Hyoung LEE, Seoul (KR); Dong Hee CHOI, Seoul (KR)

(21) Appl. No.: 19/025,355

(22) Filed: Jan. 16, 2025

(30) Foreign Application Priority Data
Jan. 19, 2024 (KR) 10-2024-0008955

(51) Int. Cl. F24F 1/0358; B01D 53/14; B01D 53/18; B01D 53/26; F24F 1/031

(52) U.S. Cl. CPC F24F 1/0358; B01D 53/1425; B01D 53/185; B01D 53/263; F24F 1/031; B01D 2257/80

(57) ABSTRACT

The present disclosure relates to a window type liquid desiccant dehumidification and ventilation system including: an air feed part having an air feed chamber consisting of an inner wall coming in contact with the inside of a building and an outer wall coming in contact with the outside of the building, a flow path being formed between the inner wall and the outer wall to allow outdoor air to be introduced into the inside of the building; a heating part for receiving a desiccant therein to heat the desiccant; a spray part for spraying the desiccant received in the heating part into the inner wall of the air feed chamber that faces the flow path to thus form a liquid film; and a cooling part for cooling the desiccant prior to spraying the desiccant into the inner wall of the air feed chamber.

### CROSS REFERENCE TO RELATED APPLICATION OF THE DISCLOSURE

The present application claims the benefit of Korean Patent Application No. 10-2024-0008955 filed in the Korean Intellectual Property Office on Jan. 19, 2024, the entire contents of which are incorporated herein by reference.

### BACKGROUND OF THE DISCLOSURE

### Field of the Disclosure

The present disclosure relates to a window type liquid desiccant dehumidification and ventilation system, more specifically to a window type liquid desiccant dehumidification and ventilation system that is capable of feeding outdoor air to the inside of a building and removing humidity from the outdoor air.

### Background of the Related Art

To keep a pleasant indoor environment from an outdoor environment with high temperature and high humidity, it is important to control humidity and temperature in an indoor space.

Among a variety of systems utilized for humidity control in indoor spaces, a liquid desiccant dehumidification system, which makes use of a liquid desiccant, has accurate humidity control capability and high energy saving potential through a cooling process using latent heat. Therefore, there are many studies on a system, to which the liquid desiccant dehumidification system is applied, capable of performing ventilation as well as appropriate dehumidification.

### SUMMARY OF THE DISCLOSURE

Accordingly, the present disclosure has been made in view of the above-mentioned problems occurring in the related art, and it is an object of the present disclosure to provide a window type liquid desiccant dehumidification and ventilation system that is capable of feeding outdoor air to the inside of a building and removing humidity from the outdoor air.

To accomplish the above-mentioned objects, according to the present disclosure, there is provided a window type liquid desiccant dehumidification and ventilation system including: an air feed part having an air feed chamber consisting of an inner wall coming in contact with the inside of a building and an outer wall coming in contact with the outside of the building, a flow path being formed between the inner wall and the outer wall to allow outdoor air to be introduced into the inside of the building; a heating part for receiving a desiccant therein to heat the desiccant; a spray part for spraying the desiccant received in the heating part into the inner wall of the air feed chamber that faces the flow path to thus form a liquid film; and a cooling part for cooling the desiccant prior to spraying the desiccant into the inner wall of the air feed chamber.

According to the present disclosure, desirably, the air feed part and the heating part may have through holes formed thereon so that the desiccant sprayed through the spray part may enter the heating part by means of the through holes.

According to the present disclosure, desirably, the air feed part may include an outdoor air inlet formed on the lower portion of the outer wall of the air feed chamber and an outdoor air outlet formed on the upper portion of the inner wall of the air feed chamber.

According to the present disclosure, desirably, the air feed part may include a partition wall located between the inner wall and the outer wall of the air feed chamber and a communication hole formed under the partition wall in such a way as to face the outdoor air inlet.

According to the present disclosure, desirably, the air feed part may further include an air feed fan located in the communication hole.

According to the present disclosure, desirably, the air feed part may include a plurality of curves repeatedly formed on the inner wall of the air feed chamber in a height direction of the inner wall of the air feed chamber.

According to the present disclosure, desirably, the heating part may include: a heating chamber located under the air feed part to receive the desiccant therein; and a heating coil located inside the heating chamber to heat the desiccant.

According to the present disclosure, desirably, the heating part may further include a solar panel located on the outside of the building to supply power to the heating coil.

According to the present disclosure, desirably, the spray part may include: a feed pump for forcedly transferring the desiccant received in the heating chamber; a desiccant line whose one end is located on the feed pump to flow the desiccant therealong; and spray nozzles located on the other end of the desiccant line above the inner wall in such a way as to spray the desiccant into the inner wall.

According to the present disclosure, desirably, the cooling part may include: a cooling chamber located above the air feed part to allow the desiccant line to pass therethrough; and a cooling coil located inside the cooling chamber to cool the desiccant line.

### BRIEF DESCRIPTION OF THE DRAWINGS

The above and other objects, features and advantages of the present disclosure will be apparent from the following detailed description of the preferred embodiments of the disclosure in conjunction with the accompanying drawings, in which:

FIG. 1 is a schematic view showing a window type liquid desiccant dehumidification and ventilation system according to a first embodiment of the present disclosure;

FIG. 2 is an enlarged view showing a portion of an air feed part of FIG. 1;

FIG. 3 is a front view showing an inner wall of FIG. 1;

FIGS. 4A and 4B are side views showing first and second examples of the inner wall of FIG. 1;

FIG. 5 is a sectional view taken along a line ‘A-A’ of FIG. 1;

FIG. 6 is an enlarged view showing a portion ‘A’ of FIG. 1; and

FIGS. 7 and 8 are schematic views showing a window type liquid desiccant dehumidification and ventilation system according to a second embodiment of the present disclosure, wherein states before and after a recovery line is open.

### DETAILED DESCRIPTION OF THE PREFERRED EMBODIMENTS

Hereinafter, embodiments of the present disclosure will be explained with reference to the attached drawings to allow the technical idea of the present disclosure to be easily understood by one of ordinary skill in the art.

Further, for reference numerals, with respect to the same elements, even though they may be displayed in different drawings, such elements use same reference numerals as much as possible.

Also, in explaining the example embodiments, detailed description on known elements or functions will be omitted if it is determined that such description will interfere with understanding of the embodiments.

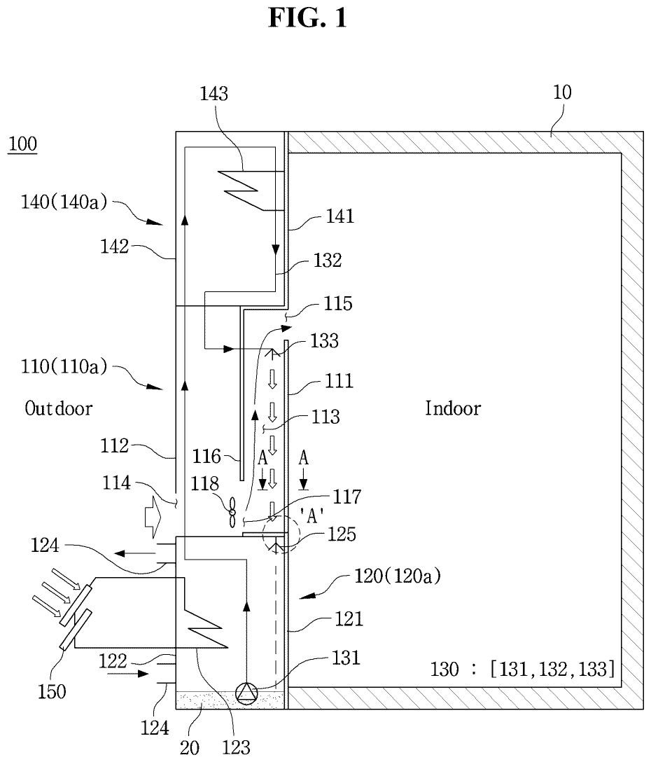

In the present disclosure, it should be understood that the term “upper”, is based on a direction toward a cooling part with respect to an air feed part as shown in FIG. 1.

Hereinafter, an explanation of a window type liquid desiccant dehumidification and ventilation system according to a first embodiment of the present disclosure will be given with reference to FIGS. 1 to 6.

FIG. 1 is a schematic view showing a window type liquid desiccant dehumidification and ventilation system according to a first embodiment of the present disclosure.

Referring to FIG. 1, a window type liquid desiccant dehumidification and ventilation system 100 (Hereinafter, referred to as ‘dehumidification and ventilation system’) according to a first embodiment of the present disclosure essentially consists of an air feed part 110, a heating part 120, a spray part 130, a cooling part 140, and a controller.

The dehumidification and ventilation system 100 is configured to allow the heating part 120, the air feed part 110, and the cooling part 140 to be stacked on top of one another sequentially and thus built, for example, on a wall of a building 10.

The controller is connected to the parts constituting the dehumidification and ventilation system 100 wiredly or wirelessly and selectively controls the operations of the parts.

The air feed part 110 includes an air feed chamber 110a consisting of an inner wall 111 coming in contact with the inside of the building 10 and an outer wall 112 coming in contact with the outside of the building 10.

The air feed chamber 110a has the shape of a hexahedron whose interior is empty, and a flow path 113 is formed between the inner wall 111 and the outer wall 112 so that outdoor air flows along the flow path 113 and is thus introduced into the inside of the building 10.

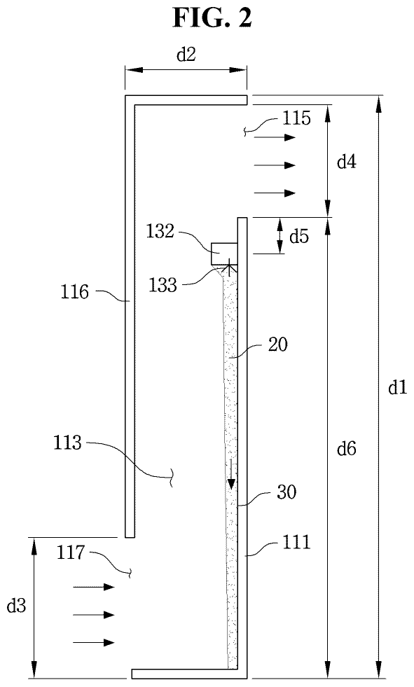

The heating part 120 receives a desiccant 20 therein and heats the desiccant 20, and the spray part 130 sprays the desiccant 20 received in the heating part 120 into the inner wall 111 of the air feed chamber 110a that faces the flow path 113 to form a liquid film 30 (See FIG. 2).

The cooling part 140 serves to cool the desiccant 20 prior to spraying the desiccant 20 into the inner wall 111 of the air feed chamber 110a.

That is, the dehumidification and ventilation system 100 feeds the outdoor air to the inside of the building 10 through the air feed part 10 and sprays the desiccant 20 into the inner wall 111 by means of a falling film method in such a way as to allow the desiccant 20 to come in contact with the outdoor air passing through the flow path 113 to thus remove humidity out of the outdoor air.

The air feed part 110 has an outdoor air inlet 114 formed on the lower portion of the outer wall 112 of the air feed chamber 110a and an outdoor air outlet 115 formed on the upper portion of the inner wall 111 of the air feed chamber 110a.

The air feed part 110 further has a partition wall 116 extending vertically from top of the air feed chamber 110a in such a way as to be located between the inner wall 111 and the outer wall 112 of the air feed chamber 110a.

The air feed part 110 has a communication hole 117 formed under the partition wall 116 in such a way as to face the outdoor air inlet 114, so that the outdoor air introduced into the outdoor air inlet 114 moves along the flow path 113, passes through the communication hole 117, and is fed to the inside of the building 10 through the outdoor air outlet 115.

The air feed part 110 further includes an air feed fan 118 located in the communication hole 117 in such a way as to be fixed to the partition wall 116 or the bottom of the air feed chamber 110a, and the air feed fan 118 forcedly transfers the outdoor air, increases the flow rate of the outdoor air, and thus enhances the efficiency for dehumidifying the outdoor air.

The air feed part 110 further includes an air feed damper and an air exhaust damper. The air feed damper is located in the outdoor air inlet 114 in such a way as to be fixed to the outer wall 112, and the air exhaust damper is fixedly located in the outdoor air outlet 115.

In this case, the controller has a predetermined flow rate of outdoor air fed to the inside of the building 10, and based on the predetermined flow rate of outdoor air, therefore, the controller adjusts opening and closing degrees of the air feed damper and the air exhaust damper.

The air feed fan 118, the air feed damper, and the air exhaust damper are fixed by means of well-known fixing members such as bolts, pieces, clamps, ties, and the like or well-known adhesion members such as silicone, glue, and the like.

Further, such fixing methods are applied for the fixation of all of the parts of the desiccant dehumidification and ventilation system 100, and an explanation of the fixing methods will be avoided for the brevity of the description.

The heating part 120 essentially consists of a heating chamber 120a and a heating coil 123.

The heating chamber 120a has the shape of hexahedron whose interior is empty and is made of a well-known material with given stiffness such as iron, synthetic resin, and the like.

The heating chamber 120a consists of an inner wall 121 coming in contact with the inside of the building 10 and an outer wall 122 coming in contact with the outside of the building 10 and is located under the air feed part 110, while receiving the desiccant 20 therein.

The heating chamber 120a communicates with the air feed chamber 110a in such a way as to introduce the desiccant 20 that removes the humidity out of the outdoor air in the air feed part 110 thereinto again, re-heat the desiccant 20, and use the desiccant 20 again.

The desiccant 20 is a well-known liquid desiccant such as lithium chloride (LiCl), calcium chloride (CaCl₂), or the like and has predetermined density of 30 or 40% at a temperature of 25° C. After the dehumidification, the diluted desiccant 20 is heated to the predetermined density and thus regenerated.

The heating coil 123 is located inside the heating chamber 120a and heats the desiccant 20.

For example, a heating wire is located inside the heating coil 123, and an electric current is applied to the heating wire to heat the desiccant 20.

The heating part 120 further includes a solar panel 150 located on the outside of the building 10 to supply power to the heating coil 123.

For another example, a high-temperature refrigerant flows inside the heating coil 123, and thermal energy of the refrigerant is applied to the desiccant 20 to heat the desiccant 20.

The desiccant dehumidification and ventilation system 100 further includes a heat pump located on the outside of the building 10 to supply a high-temperature refrigerant to the heating coil 123.

Further, the heating part 120 has ventilation holes 124 formed on upper and lower portions of the outer wall 122 of the heating chamber 120a, and the outdoor air is introduced into the heating chamber 120a through the ventilation holes 124, comes in contact with the desiccant 20, and is then emitted to the outside of the heating chamber 120a again.

That is, the desiccant 20 and the outdoor air come in contact with each other, so that the humidity in the desiccant 20 is evaporated to cause the density of the desiccant 20 to become high.

The spray part 130 essentially consists of a feed pump 131, a desiccant line 132, and spray nozzles 133, and the feed pump 131 is located inside the heating chamber 120a and forcedly transfers the desiccant 20 received in the heating chamber 120a.

The feed pump 131 is located on one end of the desiccant line 132 to allow the desiccant 20 to flow along the desiccant line 132, and the spray nozzles 133 are located on the other end of the desiccant line 132 in such a way as to be arranged above the side surface of the inner wall 111 to spray the desiccant 20 into the side surface of the inner wall 111.

The cooling part 140 serves to cool the desiccant 20 prior to using the high-temperature desiccant 20 for dehumidification and essentially consists of a cooling chamber 140a and a cooling coil 143.

The cooling chamber 140a has the shape of a hexahedron whose interior is empty and is made of a well-known material with given stiffness such as iron, synthetic resin, and the like.

The cooling chamber 140a consists of an inner wall 141 coming in contact with the inside of the building 10 and an outer wall 142 coming in contact with the outside of the building 10 and is located above the air feed part 110 in such a way as to allow the desiccant line 132 to pass therethrough.

That is, the desiccant line 132 passes through the heating chamber 120a and the air feed chamber 110a sequentially, then passes through the inside of the cooling chamber 140a, penetrates the partition wall 116 of the air feed chamber 110, and is fixedly located on the side surface of the inner wall 111.

The cooling coil 143 is located inside the cooling chamber 140a and cools the desiccant line 132.

For example, a low-temperature refrigerant flows inside the cooling coil 143, and thermal energy of the refrigerant is applied to the desiccant line 132 to cool the desiccant line 132.

The cooling part 140 further includes a chiller located on the outside of the building 10 to supply the low-temperature refrigerant to the cooling coil 143.

The desiccant 20 passes through the cooling chamber 140a along the desiccant line 132 and is thus cooled to a predetermined range of temperature.

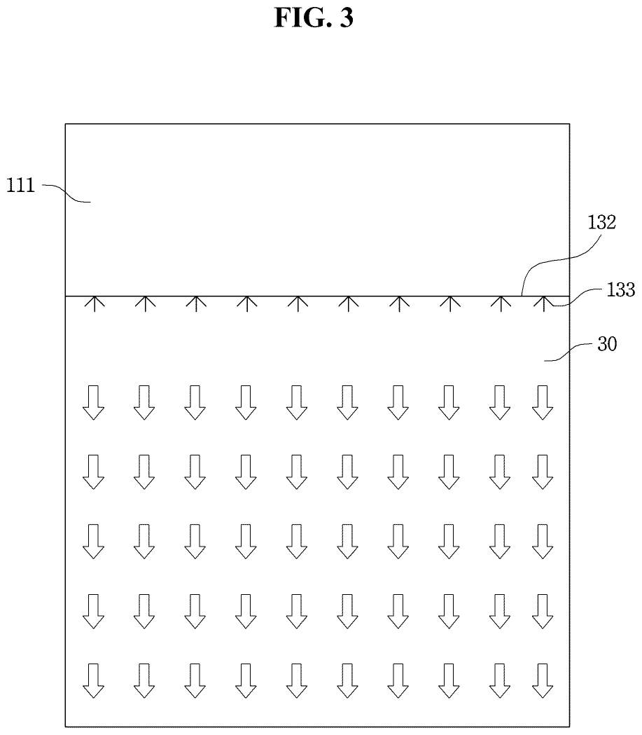

FIG. 2 is an enlarged view showing a portion of the air feed part of FIG. 1, and FIG. 3 is a front view showing the inner wall of FIG. 1.

Referring to FIGS. 2 and 3, a height of the air feed chamber 110a is 500 mm, a distance between the partition wall 116 and the inner wall 111 is 25 mm, the communication hole 117 has the size of 800×100 mm, the outdoor air outlet 115 has the size of 800×100 mm, a distance between top of the inner wall 111 and the desiccant line 132 is 25 mm, and the inner wall 111 has the size of 800×400 mm.

The desiccant line 132 is located above the inner wall 111 in a longitudinal direction of the inner wall 111, and the desiccant 20 sprayed through the spray nozzles 133 moves down along the side surface of the inner wall 111 by means of its self-weight to form the liquid film 30 on the side surface of the inner wall 111.

Further, the outdoor air passes through the communication hole 117 along the flow path 113, moves up, and comes in contact with the liquid film 30, so that humidity is removed from the outdoor air. Next, the dehumidified outdoor air is fed to the inside of the building 10 through the outdoor air outlet 115.

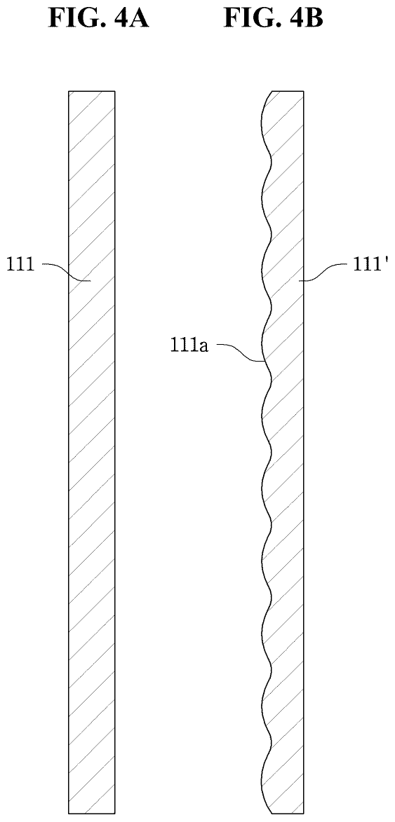

FIGS. 4A and 4B are side views showing first and second examples of the inner wall of FIG. 1.

Referring to FIG. 4A, the inner wall 111 has the shape of a flat plate and is made of a well-known material with given stiffness such as iron, synthetic resin, glass, and the like. If the inner wall 111 is made of glass, the partition wall 116 and the outer wall 112 are made of glass, so that they look like a window.

Referring to FIG. 4B, an inner wall 111′ has a plurality of curves 111a repeatedly formed on the side surface thereof in a height direction thereof so that contact areas between the inner wall 111′ and the desiccant 20 increase to enhance the dehumidifying efficiency.

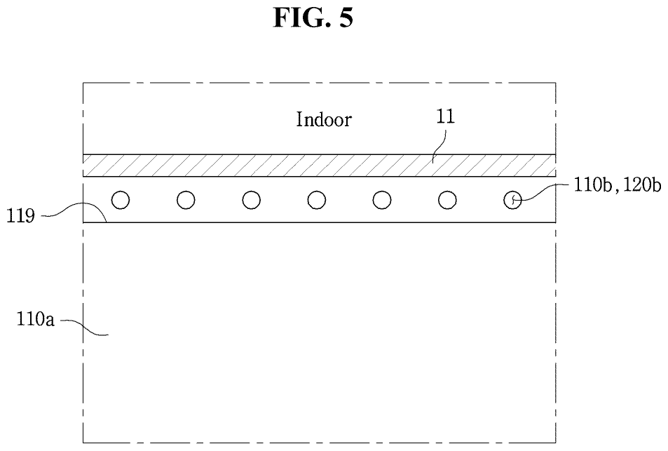

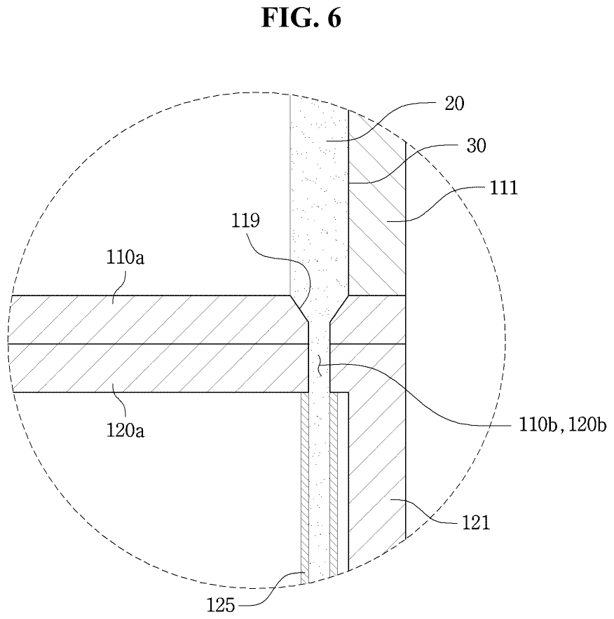

FIG. 5 is a sectional view taken along a line ‘A-A’ of FIG. 1, and FIG. 6 is an enlarged view showing a portion ‘A’ of FIG. 1.

Referring to FIGS. 5 and 6, the air feed chamber 110a has a concave groove 119 formed on the bottom thereof in the longitudinal direction of the inner wall 111 in such a way as to collect the desiccant 20 moving down along the inner wall 111, thereby ensuring the dryness of the inside thereof and increasing the recovery rate of the desiccant 20.

Further, through holes 110b are formed on the bottom of the air feed chamber 110a, and through holes 120b are formed on top of the heating chamber 120a, so that the through holes 110b and 120b communicate with the concave groove 119.

The heating part 120 further includes recovery nozzles 125, and the recovery nozzles 125 are located on top of the heating chamber 120a and communicate with the through holes 110b and 120b.

That is, the desiccant 20 collected in the concave groove 119 passes through the through holes 110b and 120b and the recovery nozzles 125 sequentially and is thus introduced into the heating chamber 120a.

Factors having influences on the dehumidification capability in the above-mentioned dehumidification and ventilation system 100 include a flow rate of outdoor air as moisture air, temperature and humidity of the outdoor air, types of liquid desiccants, temperatures and densities of liquid desiccants, and control variables and ranges of the dehumidification and ventilation system 100 are as follows.

The temperatures and humidities of the outdoor air in the outdoor air inlet 114 (as shown in FIG. 1) have the ranges of 30° C. and 70% RH, 30° C. and 80% RH, and 30° C. and 90% RH, and velocities of outdoor air in the outdoor air inlet 114 have the ranges of 0.18 m/s (0.5 times), 0.27 m/s (0.75 times), and 0.36 m/s (1.0 times).

The desiccant 20 is lithium chloride (LiCl), temperatures and densities of the desiccant 20 on the inner wall 111 have the ranges of 25° C. and 30% and 25° C. and 40%, and a flow velocity of the desiccant 20 is 0.2 m/s.

Further, estimation results for the dehumidifying capability of the dehumidification and ventilation system 100 are as follows.

Referring to the estimation results for the dehumidifying capability of the dehumidification and ventilation system 100 according to the number of ventilation times, an amount of change ΔW in absolute humidity and a dehumidifying efficiency ε decrease, but a material removal rate (MRR) increases.

The decreases in the amount of change ΔW in absolute humidity and the dehumidifying efficiency ε are caused by the reduction of the liquid desiccant 20 transferred since the contact time of the moisture air introduced with the boundary surface of the liquid desiccant 20 decreases according to the number of ventilation times increasing.

Contrarily, the MRR increases in spite of the decrease in the amount of change ΔW in absolute humidity since the flow rate of air introduced increases according to the number of ventilation times increasing.

Referring to the estimation results for the dehumidifying capability of the dehumidification and ventilation system 100 according to relative humidity of outdoor air, if the relative humidity of outdoor air becomes high, an amount of change ΔW in absolute humidity and an MRR increase, but a dehumidifying efficiency ε decreases.

As absolute humidity of moisture air introduced increases under high-humidity conditions to thus cause an amount of material transferred to increase, an amount of change ΔW in absolute humidity and a maximum water removal possibility W_{a,in}−W_{eq} increase, and accordingly, proportional to the amount of change ΔW in absolute humidity. However, the dehumidifying efficiency ε decreases under the influence of the maximum water removal possibility W_{a,in}−W_{eq}.

Referring to the estimation results for the dehumidifying capability of the dehumidification and ventilation system 100 according to densities of the liquid desiccant, if the density of the liquid desiccant becomes high, an amount of change ΔW in absolute humidity and an MRR increase, but a dehumidifying efficiency ε decreases.

The increases in the amount of change ΔW in absolute humidity and the MRR are caused by the increase in the amount of material transferred since the equilibrium absolute humidity decreases due to the change of the liquid desiccant into high density liquid desiccant.

Contrarily, the decrease in the dehumidifying efficiency ε is caused by the higher increase in the maximum water removal possibility W_{a,in}−W_{eq} than the increase in the amount of change ΔW in absolute humidity.

If the dehumidification and ventilation system 100 is applied under the condition where indoor target relative humidity is 50%, a removal rate of an amount of dehumidification needed is in the range between 32.1 and 90.8% according to ventilation conditions and liquid desiccant densities.

In this case, the removal rate of an amount of dehumidification needed is a maximum 35.8% if the number of ventilation times increases, but the removal rate of an amount of dehumidification needed is a maximum 23.8% if the relative humidity of outdoor air increases. Therefore, it can be appreciated that the influence of the number of ventilation times is greater than that of the relative humidity of outdoor air.

To ensure dehumidifying capability in controlling indoor humidity, therefore, there is a need to control a speed in the flow of air introduced through the adjustment in the number of ventilation times.

If the dehumidification and ventilation system 100 is applied to have 0.5 times as the reference for an amount of ventilation needed under the condition where indoor target relative humidity is set to 60%, a removal rate of an amount of dehumidification needed can reach a maximum 100% in a situation where the outdoor air relative humidity is 70% as an average relative humidity level in summer seasons, and therefore, it can be checked that the dehumidification and ventilation system 100 is applicable to residential buildings.

The dehumidification and ventilation system 100 can control the number of ventilation times and the desiccant densities even in the situation where the amount of dehumidification needed increases according to the indoor target relative humidity and the ventilation conditions, thereby increasing its application possibility.

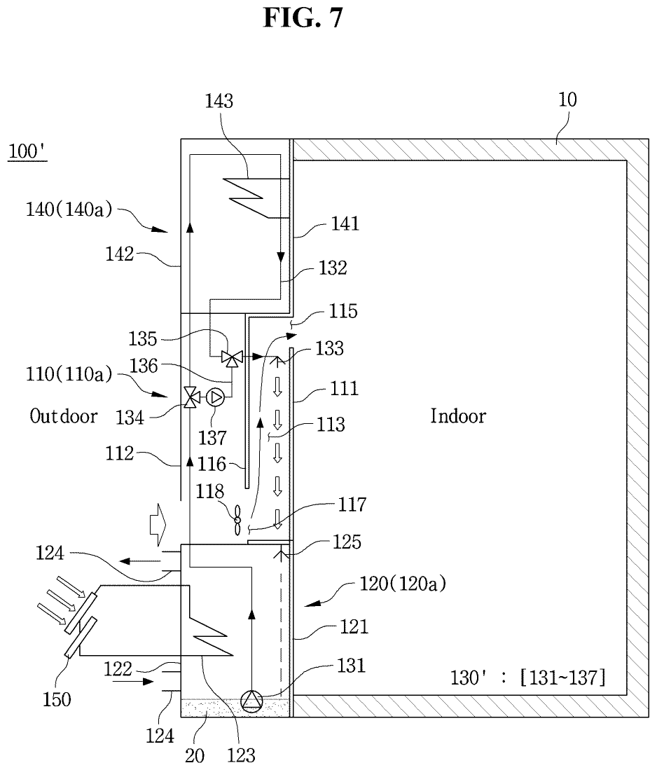

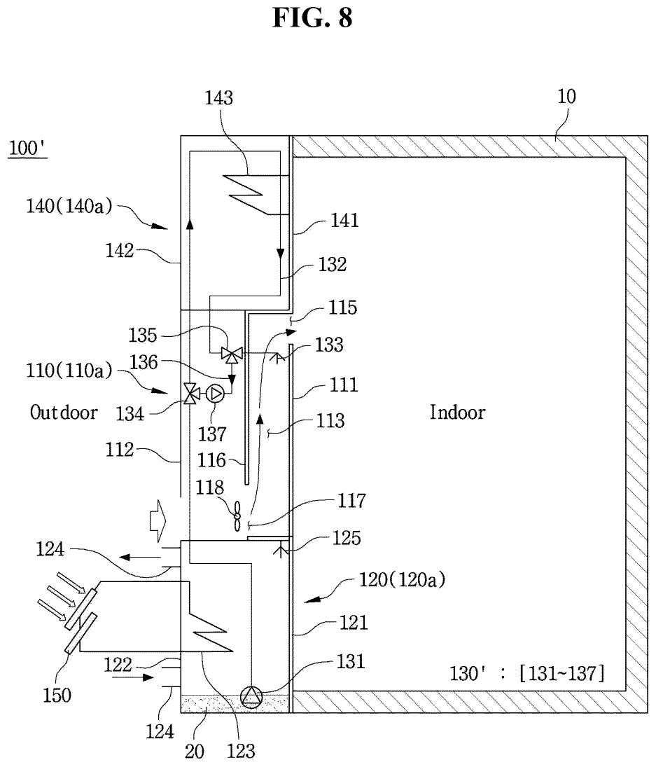

Hereinafter, an explanation of a window type liquid desiccant dehumidification and ventilation system according to a second embodiment of the present disclosure will be given with reference to FIGS. 7 and 8, and a detailed explanation of the repeated parts in the first embodiment of the present disclosure will be avoided for the brevity of the description.

FIGS. 7 and 8 are schematic views showing a window type liquid desiccant dehumidification and ventilation system according to a second embodiment of the present disclosure, wherein states before and after a recovery line is open.

Referring to FIGS. 7 and 8, a dehumidification and ventilation system 100′ according to a second embodiment of the present disclosure includes a spray part 130′ consisting of a temperature sensor, a first opening/closing valve 134, a second opening/closing valve 135, a recovery line 136, and a recovery pump 137.

The temperature sensor is mounted on the desiccant line 132 to measure a temperature of the desiccant 20 flowing along the desiccant line 132.

The first opening/closing valve 134 and the second opening/closing valve 135 are, for example, solenoid valves.

The first opening/closing valve 134 is located on the desiccant line 132 in front of the cooling chamber 140a, and the second opening/closing valve 135 is located on the desiccant line 132 behind the cooling chamber 140a.

The recovery line 136 is located between the first opening/closing valve 134 and the second opening/closing valve 135, and the recovery pump 137 is located on the recovery line 136.

The controller selectively controls the operations of the feed pump 131, the recovery pump 137, the first opening/closing valve 134, and the second opening/closing valve 135, based on the measured value of the temperature sensor, and determines whether the desiccant 20 is sprayed.

In detail, the controller operates the first opening/closing valve 134 and the second opening/closing valve 135 to allow the recovery line 136 to be closed, thereby inducing the desiccant 20 to flow toward the spray nozzles 133.

Next, the controller operates the feed pump 131 to allow the desiccant 20 received in the heating chamber 120a to be forcedly transferred through the desiccant line 132.

After that, if the temperature of the desiccant 20 passing through the cooling chamber 140a is less than a predetermined value, the controller determines that the desiccant 20 is sufficiently cooled, keeps the recovery line 136 at a closed state, and thus sprays the desiccant 20 through the spray nozzles 133.

Contrarily, if the temperature of the desiccant 20 passing through the cooling chamber 140a is greater than or equal to the predetermined value, the controller determines that the desiccant 20 is not cooled yet and thus stops the operation of the feed pump 131.

After that, the controllers operates the first opening/closing valve 134 and the second opening/closing valve 135 to allow the recovery line 136 to be open, thereby converting the desiccant line 132 into a closed-loop line.

Next, the controller operates the recovery pump 137 to allow the desiccant 20 to be forcedly transferred to the cooling chamber 140a, so that the desiccant 20 is circulated.

After that, if the temperature of the desiccant 20 passing through the cooling chamber 140a is less than the predetermined value, the controller determines that the desiccant 20 is sufficiently cooled, stops the operation of the recovery pump 137, and operates the first opening/closing valve 134 and the second opening/closing valve 135 to allow the recovery line 136 to be closed.

Next, the controller operates the feed pump 131 and forcedly transfers the desiccant 20, so that the desiccant 20 is sprayed through the spray nozzles 133.

As mentioned above, the window type liquid desiccant dehumidification and ventilation system according to the present disclosure can form the flow path between the inner wall coming in contact with the inside of the building and the outer wall coming in contact with the outside of the building, so that outdoor air is fed to the inside of the building along the flow path.

Further, the window type liquid desiccant dehumidification and ventilation system according to the present disclosure can allow the desiccant to be sprayed into the inner wall by means of the falling film method, so that the desiccant comes in contact with the outdoor air passing through the flow path, thereby removing the water contained in the outdoor air.

Moreover, the window type liquid desiccant dehumidification and ventilation system according to the present disclosure can allow the desiccant that is used to remove humidity from the outdoor air to be heated and cooled, so that the desiccant is used again to remove humidity from the outdoor air.

The embodiments of the present disclosure have been made in the specification and drawings. In the description of the present disclosure, special terms are used not to limit the present disclosure and the scope of the present disclosure defined in claims, but just to explain the present disclosure. Therefore, persons skilled in the relevant art can appreciate that many modifications and variations are possible in light of the above teachings. It is therefore intended that the scope of the disclosure be limited not by this detailed description, but rather by the claims appended hereto.

What is claimed is:

1. A window type liquid desiccant dehumidification and ventilation system comprising:
an air feed part having an air feed chamber consisting of an inner wall coming in contact with the inside of a building and an outer wall coming in contact with the outside of the building, a flow path being formed between the inner wall and the outer wall to allow outdoor air to be introduced into the inside of the building;
a heating part for receiving a desiccant therein to heat the desiccant;
a spray part for spraying the desiccant received in the heating part into the inner wall of the air feed chamber that faces the flow path to thus form a liquid film; and
a cooling part for cooling the desiccant prior to spraying the desiccant into the inner wall of the air feed chamber.

2. The window type liquid desiccant dehumidification and ventilation system according to claim 1, wherein the air feed part and the heating part have through holes formed thereon so that the desiccant sprayed through the spray part enters the heating part by means of the through holes.

3. The window type liquid desiccant dehumidification and ventilation system according to claim 1, wherein the air feed part comprises an outdoor air inlet formed on the lower portion of the outer wall of the air feed chamber and an outdoor air outlet formed on the upper portion of the inner wall of the air feed chamber.

4. The window type liquid desiccant dehumidification and ventilation system according to claim 3, wherein the air feed part comprises a partition wall located between the inner wall and the outer wall of the air feed chamber and a communication hole formed under the partition wall in such a way as to face the outdoor air inlet.

5. The window type liquid desiccant dehumidification and ventilation system according to claim 4, wherein the air feed part further comprises an air feed fan located in the communication hole.

6. The window type liquid desiccant dehumidification and ventilation system according to claim 1, wherein the air feed part comprises a plurality of curves repeatedly formed on the inner wall of the air feed chamber in a height direction of the inner wall of the air feed chamber.

7. The window type liquid desiccant dehumidification and ventilation system according to claim 1, wherein the heating part comprises:
a heating chamber located under the air feed part to receive the desiccant therein; and
a heating coil located inside the heating chamber to heat the desiccant.

8. The window type liquid desiccant dehumidification and ventilation system according to claim 7, wherein the heating part further comprises a solar panel located on the outside of the building to supply power to the heating coil.

9. The window type liquid desiccant dehumidification and ventilation system according to claim 1, wherein the spray part comprises:
a feed pump for forcedly transferring the desiccant received in the heating chamber;
a desiccant line whose one end is located on the feed pump to flow the desiccant therealong; and
spray nozzles located on the other end of the desiccant line above the inner wall in such a way as to spray the desiccant into the inner wall.

10. The window type liquid desiccant dehumidification and ventilation system according to claim 9, wherein the cooling part comprises:
a cooling chamber located above the air feed part to allow the desiccant line to pass therethrough; and
a cooling coil located inside the cooling chamber to cool the desiccant line.
